(19) United States
(12) Patent Application Publication
(10) Pub. No.: US 2026/0252795 A1
(43) Pub. Date: Aug. 27, 2026

(54) AUTO-COMPLETION OF FORM FIELDS

(71) Applicant: Microsoft Technology Licensing, LLC, Redmond, WA (US)

(72) Inventors: Liang GU, Lexington, MA (US); Matthew Reinhard HOHENSEE, Seattle, WA (US); Nathan Joseph IMSE, Seattle, WA (US)

(21) Appl. No.: 19/061,349

(22) Filed: Feb. 24, 2025

(51) Int. Cl. G06F 40/274; G06F 3/023; G06F 40/174

(52) U.S. Cl. CPC G06F 40/274; G06F 3/0237; G06F 40/174

(57) ABSTRACT

Techniques for providing autocomplete predictions in a web form in a low latency manner are disclosed. A service accesses a field in the web form. The service causes its client device to operate in an active state in which the client device is permitted to submit autocomplete prediction requests to a server. Prior to receiving user input directed to the field, the service receives an indexed data structure comprising autocomplete predictions for the field. The service causes the client device to then operate in a paused state. The indexed data structure is saved locally. The service then locally queries the locally saved data structure to display predictions for the field and avoids sending network calls to the server for more predictions.

### BACKGROUND

A “web form” refers to a webpage element that is interactive, such as by allowing users to enter input data. Examples of such data include, but certainly are not limited to, the user's name, username, email alias, account information, and so on. Often, though not always, the web form is created using HTML code. Additional forms of code can be used as well, such as client-script, server code, and server controls.

Web forms are a form of a web page that a user can request via a web browser. When a web form is requested by a user, the web form is often compiled and then executed on a server, such as by the server's framework. The server generates the web form in a manner so that the client's web browser can display the web form.

Typically, a web form will include any number of elements or “fields.” As mentioned above, these fields are structured to receive input, often in an interactive manner with a user. The web form and the fields are expressed or presented to the user in a graphical manner. The fields can be of any type. Examples of some fields include, but are not limited to, text boxes, pull down boxes, radio buttons, check boxes, and so on. Some fields operate as selectable options, such as a “submit” button. In this scenario, pressing the submit button generates a pre-defined type of input.

Currently, some web forms are configured to enable autocompletion via the use of a process called “Form Predict.” Form predict refers to the use of detected data patterns to predict or anticipate what the state or value of a given field in a form will be. In effect, form predict relies on observed trends and patterns to make a prediction as to what value will likely be entered into a web form's fields.

Form predict, in some implementations, uses one or more previous forms called an MRU (Most Recently Updated form) to attempt to predict values when a user opens a new form. For each field in the form, the form predict process tabulates the values entered in the MRUs and uses the frequencies and counts to determine whether to make a prediction and, if so, what to predict. In general, the most frequently seen value is predicted, often with several caveats however (e.g., no predictions might be made if there is an insufficient number of MRUs). This generalized process is often referred to as the “1-best” prediction process. The “1-best” process refers to making a single prediction for each field, regardless of how the prediction is generated. Because web forms are so prevalent, there is a substantial need to improve the autocomplete and prediction operations involved with web forms.

The subject matter claimed herein is not limited to embodiments that solve any disadvantages or that operate only in environments such as those described above. Rather, this background is only provided to illustrate one exemplary technology area where some embodiments described herein can be practiced.

### BRIEF SUMMARY

In some aspects, the techniques described herein relate to a method implemented by a client device that communicates with a server, said method including: accessing a web form including a field that is structured to receive a data value; causing the client device to operate in an active state in which the client device is permitted to submit autocomplete prediction requests to the server; prior to receiving user input directed to the field, receiving, from the server, an indexed data structure including a set of autocomplete predictions that are tailored to operate as the data value for the field; after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value; prior to the user input being entered into the field, displaying a first autocomplete prediction that is selected by the client device from the set of autocomplete predictions; in response to identifying a single value being entered into the field, displaying a second autocomplete prediction that is selected by the client device from the set of autocomplete predictions, wherein the second autocomplete prediction is selected by the client device based on the client device querying the indexed data structure using the single value; in response to receiving a selection of the second autocomplete prediction, populating the field using the second autocomplete prediction; and after the field is populated using the second autocomplete prediction, causing the client device to transition from the paused state to the active state.

In some aspects, the techniques described herein relate to a method implemented by a client device that communicates with a server, said method including: accessing a web form including a field that is structured to receive a data value; causing the client device to operate in an active state in which the client device is permitted to submit autocomplete prediction requests to the server; prior to receiving user input directed to the field, receiving, from the server, an indexed data structure including a set of autocomplete predictions that are tailored to operate as the data value for the field; after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value; prior to the user input being entered into the field, displaying a first autocomplete prediction that is selected by the client device from the set of autocomplete predictions; in response to identifying a single value being entered into the field, displaying a second autocomplete prediction that is selected by the client device from the set of autocomplete predictions, wherein the second autocomplete prediction is selected by the client device based on the client device querying the indexed data structure using the single value; in response to additional values being progressively entered into the field thereby forming a particular value, determining that the set of autocomplete predictions does not include the particular value; refraining from displaying any autocomplete prediction included in the set of autocomplete predictions; after the field is populated using the particular value, causing the client device to transition from the paused state to the active state; and transmitting the particular value to the server.

In some aspects, the techniques described herein relate to a method implemented by a client device that communicates with a server, said method including: accessing a web form including a field that is structured to receive a data value; causing the client device to operate in an active state in which the client device is permitted to submit autocomplete prediction requests to the server; prior to receiving user input directed to the field, receiving, from the server, an indexed data structure including a set of autocomplete predictions that are tailored to operate as the data value for the field; after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value; prior to the user input being entered into the field, displaying a first autocomplete prediction that is selected by the client device from the set of autocomplete predictions; in response to identifying a single value being entered into the field, displaying a second autocomplete prediction that is selected by the client device from the set of autocomplete predictions, wherein the second autocomplete prediction is selected by the client device based on the client device querying the indexed data structure using the single value; in response to one or more additional values being progressively entered into the field thereby forming a particular value, determining that the set of autocomplete predictions does include the particular value; in response to receiving a selection of the particular value, which is displayed as an autocomplete suggestion, populating the field using the particular value; and after the field is populated using the particular value, causing the client device to transition from the paused state to the active state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or can be learned by the practice of the teachings herein. Features and advantages of the invention can be realized and obtained by means of the instruments and combinations particularly pointed out in the appended claims. Features of the present invention will become more fully apparent from the following description and appended claims, or can be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture structured to facilitate the use of predictions for a web application form.

FIG. 2 illustrates an example of a web application form.

FIG. 3 illustrates another example architecture demonstrating various operations between a client device and a server.

FIG. 4 illustrates a process flow performed by the client device.

FIGS. 5A, 5B, 5C, 5D, and 5E illustrate an example scenario in which predictions are displayed for a field of a form.

FIGS. 6A and 6B illustrate a flowchart of an example method for facilitating the use of predictions in a low latency manner.

FIG. 7 illustrates an example computer system that can be configured to perform any of the disclosed operations.

### DETAILED DESCRIPTION

Because web forms are so prevalent, there is a substantial need to improve the autocomplete and prediction operations involved with web forms. The disclosed embodiments provide various solutions, benefits, advantages, and practical applications to address these needs.

For instance, one implementation of form predict in PowerApps v1 presents a set of predictions to the user, and those set of predictions are either accepted or rejected by the user. The disclosed embodiments improve upon such systems. For instance, at least one embodiment is beneficially able to store a list of predictions for each field in a web form. By doing so, at least one embodiment can beneficially continue to refine the predictions as the user enters input into a given field, thereby leveraging the typed characters to inform subsequent predictions.

That is, by storing a list of predictions for each field of a web form, the disclosed embodiments are beneficially able to continue to make predictions even after the user begins typing, such as in the case where the 1-best prediction was incorrect or in the case where no prediction was made. As one example, consider a scenario where the most common value in the MRUs is “January,” and the second most common value is “February.” The 1-best prediction will be “January.” With traditional systems, if the user were to begin to type “February,” that user will be required to type the entire word, and the user will not benefit from the prediction. The disclosed embodiments, on the other hand, are dynamically able to provide an n-best number of predictions, which are tailored based on additional input the user provides. For instance, in the above example, if the user were to type the character “F,” at least one embodiment can dynamically change the prediction for this field to “February,” thereby allowing the user to save multiple keystrokes. Although many of the examples recited herein involve the use of an MRU as the source for generating predictions, it will be appreciated how other sources can be used as well. For instance, another example of a source can be a user's address book, email text, or any other document that can provide additional context. In some cases, geographical location data from a gazetteer can also be used. Accordingly, numerous different types of sources can be involved.

The disclosed embodiments also significantly reduce the prediction latency that traditional autocomplete or prediction systems have. With traditional systems, those systems make repeated network calls to the server to obtain an updated prediction based on the user's input. Often, these updated predictions are generated by a large language model (LLM). Calls to an LLM are often quite computationally expensive and are often time intensive, thereby leading to increased latency. With multiple calls being made to the server, one can appreciate how latency on the client-side will escalate.

The disclosed embodiments significantly reduce latency by making a single network call to the server in order to obtain a data structure, listing, or dictionary of predictions for each field in a web form. This data structure is a static data structure in that the predictions in the data structure remain constant and unchanged.

In some implementations, this single network call can be performed even before the user navigates to the web form. In other implementations, the single network call is performed in response to the user navigating to the web form. After this single network call is made, the client device will receive, from the server, the data structure, which includes a set of predictions for the form's field. The predictions in the data structure are indexed and are assigned confidence metrics based on their likelihood of use. Notably, as will be discussed in more detail later, the predictions in the data structure are generated on the server (e.g., perhaps by an LLM) and are, at least to some extent, generated based on a history associated with the field. Again, further details on this aspect will be provided.

After the client device receives the data structure, the data structure is stored locally in the client device's cache. The client device then refrains from issuing another network call to the server for at least a threshold period of time. Thus, instead of making multiple network calls to obtain predictions, the client device makes a single network call, obtains a static set of predictions, and then locally queries the data structure of predictions in order to provide one or more predictions to the user who is interacting with a field in the web form. By making these local queries as opposed to submitting multiple network calls, at least one embodiment can significantly reduce the latency that has historically been a part of surfacing predictions for a web form's field. Accordingly, these and many other benefits and advantages will be provided in more detail throughout the remaining portions of this disclosure.

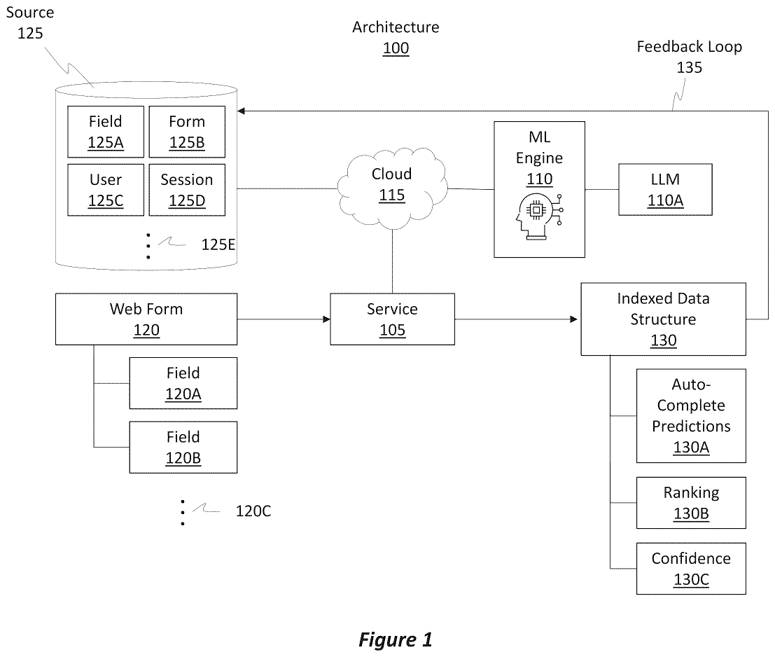

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented on any type of computing system.

As used herein, the term “service” refers to an automated program that is tasked with performing different actions based on input. In some cases, service 105 can be a deterministic service that operates fully given a set of inputs and without a randomization factor. In other cases, service 105 can be, can include, or can access a machine learning (ML) or artificial intelligence engine, such as ML engine 110. The ML engine 110 enables the service to operate even when faced with a randomization factor. ML engine 110 can include any type of large language model (LLM) 110A.

As used herein, reference to any type of machine learning, LLM, or artificial intelligence can include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data can be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud 115 and a local component operating on a local device. These two components can communicate with one another. In many implementations disclosed herein, an instance of the service 105 is operating on a local client device and a different instance of the service 105 is operating on a server in the cloud 115. These two instances can cooperate and communicate with one another to perform the disclosed operations. Often, the ML engine 110 and the LLM 110A are implemented on the server in the cloud 115. In some scenarios, however, the ML engine 110 and the LLM 110A can reside on the client device. In most implementations, the ML engine 110 and the LLM 110A are implemented on the server in the cloud 115.

Service 105 is tasked with facilitating the generation and display of a set of predictions for a given field in a web form in a low latency manner. In one example scenario, service 105 is residing on a client device. Another instance of service 105 can be residing on a server in the cloud 115.

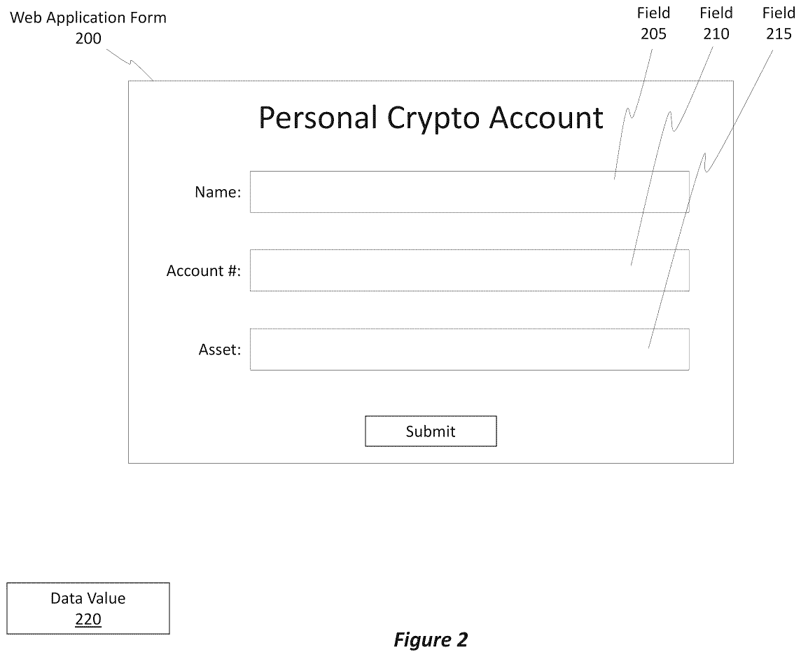

Service 105 accesses a web form 120 that is currently displayed, will subsequently be displayed, or is in the process of being displayed on the client device. The web form 120 includes any number of fields, such as field 120A and field 120B. The ellipsis 120C demonstrates how any number of fields can be included in the web form 120. FIG. 2 provides a brief illustration.

FIG. 2 shows a web application form 200 that corresponds to the web form 120 of FIG. 1. Web application form 200 includes a number of fields, such as fields 205, 210, and 215. Some fields have strict type definitions such that data of only a specific predetermined type is permitted to be entered into the field. Other fields can have an unlimited type definition in which any type of data can be entered therein. In any event, a data value 220 can be entered into the fields. Data value 220 can include a single character entry or multiple characters. Thus, reference to a data value 220 should be interpreted as covering a scenario in which one or more characters are entered.

Returning to FIG. 1, service 105 submits a network call to the server residing in the cloud 115. The server is able to access a source 125 to assist in generating a set of predictions for the web form 120, and in particular for each field in the web form 120 (e.g., fields 120A and 120B).

Source 125 can include any type of information for the web form 120 and/or for the user who is interacting with the web form 120. For instance, source 125 can include history data for a specific field 125A in the web form 120 (i.e. field history data). Source 125 can include history data for a specific form 125B (e.g., form history data). Source 125 can include history data for a specific user 125C (e.g., user history data). Source 125 can include history data for a specific user session 125D (e.g., session history data). The ellipsis 125E demonstrates how source 125 can include other historical data.

By way of further explanation, the field history data can include history data that has been collected and stored for a specific field of a web form. Any number of users can have previously interacted with a particular field, and those interactions can be monitored to produce the field history data. Such interactions can include those users entering specific values into the field, and those specific values can be included in the field history data. Thus, granular history data can be acquired for particular fields of a web form. If the history data in the source 125 is viewed in a hierarchical manner, the field history data can be viewed as being highly granular or at the lowest level of the hierarchy.

Regarding the form history data, the form history data can be viewed as being one or more levels higher in the hierarchy as compared to the field history data. The form history data can include past user interactions any number of users have had with the given form as a whole. Such interactions can include data describing when, how, and to what extent users interacted with the web form. The form history data can include details on what types of data were entered into the form, the cadence or frequency the form was interacted with, what types of users interacted with the form, and so on, without limit.

Regarding the user history data, data for a particular user can be obtained in the form of history data. For instance, a given user can be associated with a profile or user history data. The interactions the user has with other forms, web browsers, or even more generally with a computer system can be monitored, and the data collected from those monitoring activities can be included in the user history data. Thus, if a user follows a pattern in how the user enters information or a pattern in the type of information entered, these patterns can be detected and included in the user history data.

Finally, regarding the session history data, a “session” is generally referred to as a period of time during which a user interacts with a digital platform. For instance, the user can initially interact with the web form 120, briefly navigate away from the web form 120, and then return to the web form 120 within a threshold amount of time (e.g., so as to not time out of the session). These activities can be included in the same session. Activities can be recorded during a given session, and the information describing those activities can be included in the session history data. Accordingly, source 125 can include a plethora of historical data to assist the server in the cloud 115 in generating a set of autocomplete predictions for fields of the web form 120. The LLM 110A can also generate data on its own accord based on its learning and context for the web form 120.

Using the source 125, the server in the cloud 115 will generate an indexed data structure 130 and provide that indexed data structure 130 to the service 105 operating on the client device. The server in the cloud 115 can generate the indexed data structure 130 using the ML engine 110 and/or the LLM 110A.

Regarding the “indexed data structure,” it is often the case that the work performed to decide what predictions to display for a given input string is done ahead of time on the server. That is, the server can be integrating and choosing between multiple potential predictions from the MRUs or other sources. One particularly relevant aspect to note is that all of this work (in some embodiments) is done on the server and is baked into a data structure (e.g., the indexed data structure) which can be accessed via a single string. That is, in some implementations, all of the information sources are combined and distilled into a table that maps any arbitrary sequence of characters to a set of predictions. The data structure can be referred to as a “hash table” or a “dictionary.”

A corresponding indexed data structure is generated for each field in the web form 120. For instance, the indexed data structure 130 can specifically be generated for field 120A. A different indexed data structure can specifically be generated for field 120B. Each of the generated indexed data structures can be structured in the same manner, though they will have different information included therein. Alternatively, they can have different structures or configurations.

The indexed data structure 130 is structured by the server to include a set of autocomplete predictions 130A for the field 120A. These autocomplete predictions 130A are assigned a ranking 130B in the indexed data structure 130 based on a confidence 130C metric or frequency metric that is assigned to each prediction. As one example, the indexed data structure 130 can be organized where the 1-best prediction has the highest ranking because it has the highest confidence metric. The other autocomplete predictions in the indexed data structure 130 can follow the 1-best prediction based on their respective rankings and confidences. Often, the number of predictions in the autocomplete predictions 130A is large, such as over 100 for each field. In some scenarios, the number of predictions is a value within a range spanning from 100 to 1,000. In some scenarios, the number of predictions is over 1,000.

It should also be noted how the indexed data structure 130 is indexed and is searchable in a fast and low latency manner and can be run in constant time. That is, the time required to look up the set of predictions for a given input string is independent of both the length of the input string and the total number of predictions available. The client does not actually need to do any filtering or pruning as this is already taken care of in the data structure. If the user were to type the letter “F” into the field 120A, service 105 (operating on the client device) need not search through the entire set of autocomplete predictions 130A in the indexed data structure 130. Instead, similar to how a dictionary is structured, service 105 can immediately navigate to the portion of the indexed data structure 130 where the predictions starting with the letter “F” are located. In this sense, service 105 can perform filtering and pruning in its search of the indexed data structure 130.

Different techniques are available with regard to how one or more of the autocomplete predictions 130A are displayed to the user. For instance, if the user has not yet entered any values into the field 120A, one or more of the autocomplete predictions 130A can be displayed at a location that is proximate or that is overtop (at least by some amount) of the field 120A. In some scenarios, only a single autocomplete prediction is displayed at any given time while in other scenarios, multiple autocomplete predictions are simultaneously displayed. As the user progressively enters more characters into the field 120A, the indexed data structured 130 can be queried locally to obtain updated predictions, if available.

In some scenarios, the values that are entered into the field 120A will result in no predictions being available in the indexed data structure 130 (e.g., because no predictions match the entered values). In such scenarios, service 105 will still refrain from submitting a network call to the server to obtain additional predictions; instead, service 105 will cause no predictions to be displayed. Thus, if predictions are not available in the indexed data structure 130 based on the value(s) entered into the field 120A, service 105 will refrain from displaying any predictions and will also refrain from submitting network calls to the server in an attempt to obtain predictions.

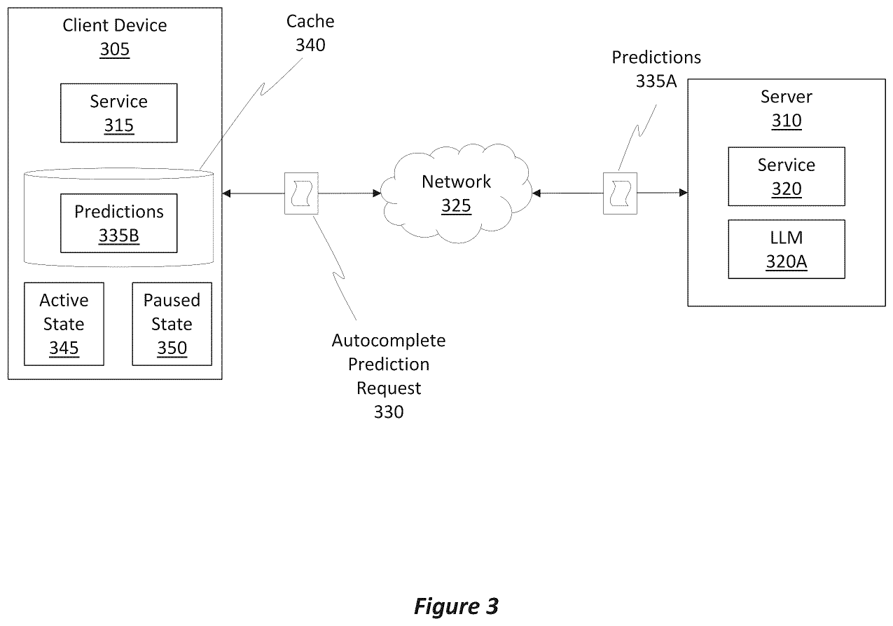

Such operations are distinct relative to traditional autocomplete scenarios that do submit subsequent or additional network call to the server. In this manner, service 105 relies on a static, non-changing (at least for a period of time) indexed data structure 130. In the event that no predictions are available for a given value entered into the field 120A, service 105 can (at a later time) submit that value to the server in the cloud 115 in the form of the feedback loop 135 so as to update the source 125 for the field 120A. By updating the source 125, that value can appear as a prediction during a subsequent iteration in which predictions are surfaced for the field 120A. FIG. 3 provides some additional details.

FIG. 3 shows an example architecture 300 that includes a client device 305 and a server 310. Client device 305 includes an instance of the service 315, and server includes an instance of the service 320. Services 315 and 320 can be instances of the service 105 from FIG. 1. Service 315 communicates with service 320, or more generally with server 310, over the network 325.

In accordance with the disclosed principles, service 315 will submit one autocomplete prediction request 330 to the service 310. Service 310 will then generate an indexed data structure that includes a set of predictions 335A. These predictions 335A correspond to the autocomplete predictions 130A of FIG. 1. Also, these predictions 335A are generated for a particular field in a web form. The predictions 335A can be generated by an LLM 320A operating in the cloud and potentially on the server 310. Server 310 will then transmit the predictions 335A to the client device 305. It should be noted how many of the examples recited herein involve the client submitting a request to the server. Such a scenario is but one example implementation and is not required in all implementations. For instance, some embodiments are structured such that the server automatically sends data to the client without the client having to submit a request. As another example, the server can send predictions for all fields as soon as the form is opened or as soon as some other triggering condition occurs.

Service 315 will receive the predictions 335A and store the predictions (now shown as predictions 335B) in a cache 340/memory of the client device 305. Service 315 will then submit local queries to the cache 340 against the predictions 335B in order to generate and display relevant predictions for the given field.

FIG. 3 also shows how the client device 305 can operate in various different modes or states. For instance, these states include an active state 345 and a paused state 350. When the client device 305 is operating in the active state 345, the client device 305 is permitted to submit autocomplete prediction requests to the server 310. When the client device 305 is operating in the paused state 350, the client device 305 is caused to refrain (or is prevented) from submitting any requests for additional autocomplete predictions to the server 310.

By way of further example, when the client device 305 submits the autocomplete prediction request 330, the client device 305 is operating in the active state 345. Either after the client device 305 submits the autocomplete prediction request 330 or after the predictions 335B are received and/or stored in the cache 340, the client device 305 transitions from operating in the active state 345 to operating in the paused state 350. While the client device 305 is operating in the paused state 350, the client device 305 locally queries the predictions 335B and displays one or more of those predictions 335B while the user is interacting with the form. Also, while the client device 305 is operating in the paused state 350, the client device is prevented from submitting additional prediction requests (for the specific field currently in focus) to the server 310.

It can be the case that one of the predictions 335B is relevant (i.e. is the value the user desires) and is selected by the user. It can alternatively be the case that none of the predictions 335B are relevant and none are selected by the user. In both scenarios, the client device 305 is operating in the paused state 350, such that no additional autocomplete prediction requests are being submitted to the server 310. To be clear, even if none of the predictions 335B are relevant based on the user input entered into the field (resulting in none of the predictions 335B being displayed to the user), the client device 305 continues to operate in the paused state 350. Thus, the client device 305 relies on static data in the form of the predictions 335B.

In the event the user does not select any of the predictions 335B, the client device 305 will continue to operate in the paused state 350 until such time as no further input is being entered into the field. After the field is populated to completion, the client device 305 can transmit the entered value to the server 310 so the server 310 can update the history source (e.g., source 125 from FIG. 1). Additionally, after the field is populated to completion, the client device 305 can transition from operating in the paused state 350 back to operating in the active state 345. An updated data structure of predictions can then be acquired from the server 310.

By performing the above operations, the disclosed embodiments significantly reduce latency because only a single network call is made to the server 310 to acquire the predictions 335B. Often, this network call is made even before the user is ready to enter input into the data field. As a result, the user does not experience any latency.

It can be the case that the set of predictions 335B is not sufficient, resulting in a scenario where no predictions are displayed to the user based on the values entered into the field. Regardless, at least one embodiment refrains from submitting additional autocomplete prediction requests until a later time, such as when the field is populated to completion (despite no predictions being displayed or being used). In this manner, at least one embodiment does potentially sacrifice some accuracy in terms of prediction in order to gain improvements in terms of latency. For example, in the scenario where no prediction is correct (i.e. the correct prediction is not in the data structure), there is no initial way to generate the correct prediction. Updated source can potentially be used, however, if the service were allowed to repeat network calls back to the server during the current use of the field, but that is not the case here. The initial assumption is that the server has included every possible prediction it could come up with in the data structure based on the current state of the history or source. Accuracy loss potentially occurs due to the source not being dynamically updated.

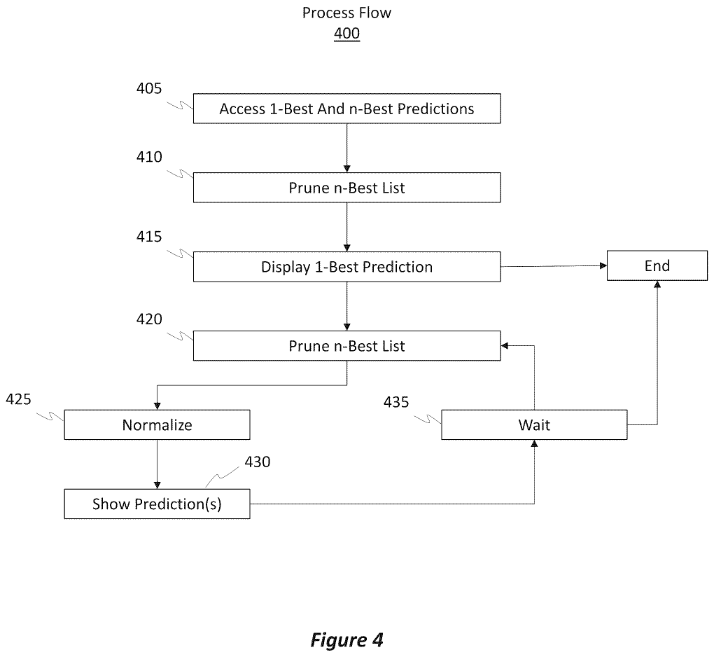

FIG. 4 shows an example process flow 400 that generally illustrates the operations performed within architecture 300 of FIG. 3. More specifically, process flow 400 is performed by the service 315 residing on the client device 305. It should be noted how these following sections, along with FIG. 4, describe a different implementation of the n-best/autocomplete functionality, where the prediction list is being pruned on the client device in real time as the user enters data. An alternative flowchart that is analogous to FIG. 4 would describe a simple loop on the client side between waiting for user input and looking up the input in the dictionary. In such a scenario, the pruning, normalizing, and thresholding described are all part of the assembly of the data structure on the server and are specific to an implementation based only on MRUs. One particularly relevant aspect is that the data structure (however it is created) allows the client to efficiently map the character sequence typed by the user to a ranked list of predictions.

Initially, process flow 400 includes an act (act 405) of accessing the 1-best prediction as well as the n-best predictions. These predictions are included in the data structure mentioned earlier, where that data structure is generated by the server 310 of FIG. 3.

Act 410 then includes pruning the n-best list by removing entries having a frequency or confidence metric lower than a defined threshold. Act 415 then includes displaying the 1-best prediction to the user. Optionally, one or more of the n-best predictions can also be displayed. In the event a determination is made that the user is no longer interacting with the given field, process flow 400 will end. Also, if the user selects the 1-best prediction, the process flow 400 will end.

If, however, the user enters a value into the given field, act 420 will commence. If act 420 commences, then that means the 1-best prediction was not the value the user desired to enter into the field. Thus, act 420 involves pruning the n-best list by removing all entries that do not match the user's input.

Act 425 then includes normalizing the frequencies or confidence metrics of the remaining entries and pruning the list so that only entries having frequencies above a given threshold are retained. Entries having frequencies below the threshold are pruned (i.e. removed).

Act 430 then provides the option of showing one or more of the top remaining predictions. If only a single prediction remains, that single prediction is displayed. If multiple predictions remain, one or more of those predictions can be displayed. If no predictions remain, then no predictions will be displayed.

Act 435 includes waiting for additional input from the user. If the user enters additional input, act 420 and the acts that follow act 420 can be repeated. If the user leaves the field, then process flow 400 can end.

In some embodiments, an n-best prediction pass is performed subsequent to the 1-best pass. Similar to the 1-best pass, the n-best pass filters out values that are not attested in a minimum number of MRUs and returns a list of possible predictions along with their frequencies. In some implementations, a minimum of two distinct values are required to be included in MRUs in order to make a prediction. In some implementations, the size of the n-best list is capped at 1,000.

To continue with the above example, at evaluation time, the 1-best prediction is first compared to a ground truth. If it is correct, at least one embodiment treats it as an accepted prediction and stop the process. If not, at least one embodiment proceeds to the n-best predictions, simulating the sequence of user keystrokes using the ground truth. After each keystroke, at least one embodiment removes from the n-best list all predictions that do not match the entered keystrokes. The remaining probability mass is then redistributed among the surviving predictions.

Some embodiments then apply a frequency threshold, removing all predictions with a frequency lower than the threshold. Note, the frequencies of the surviving predictions either remain constant or increase each time they are recalculated (e.g., because the total number of predictions stays the same or decreases), so the threshold increases after each keystroke. At least one embodiment therefore calculates the threshold dynamically as a function of the number of keystrokes entered. After applying the frequency threshold, if there is one prediction remaining, at least one embodiment can display that prediction to the user. If it is correct, at least one embodiment treats it as accepted and stop the process. If not, the process continues. If there are zero predictions remaining, at least one embodiment can delete any previously shown prediction and stop.

In the above example, there is a tradeoff between keystroke savings and precision. The more predictions at least one embodiment acquires, the greater potential there is for saving keystrokes by predicting correctly. But, along with that scenario comes the potential for displaying incorrect predictions. So, the disclosed embodiments operate by balancing keystroke savings with precision. One consideration for impacting this balance is that the keystroke savings correlates directly with time saved for the user, and precision is merely a measure of the predictions the user sees. So, while low keystroke savings mean less time savings for the user, low precision means the user is seeing incorrect predictions, which can be annoying for the user but which do not impact time savings.

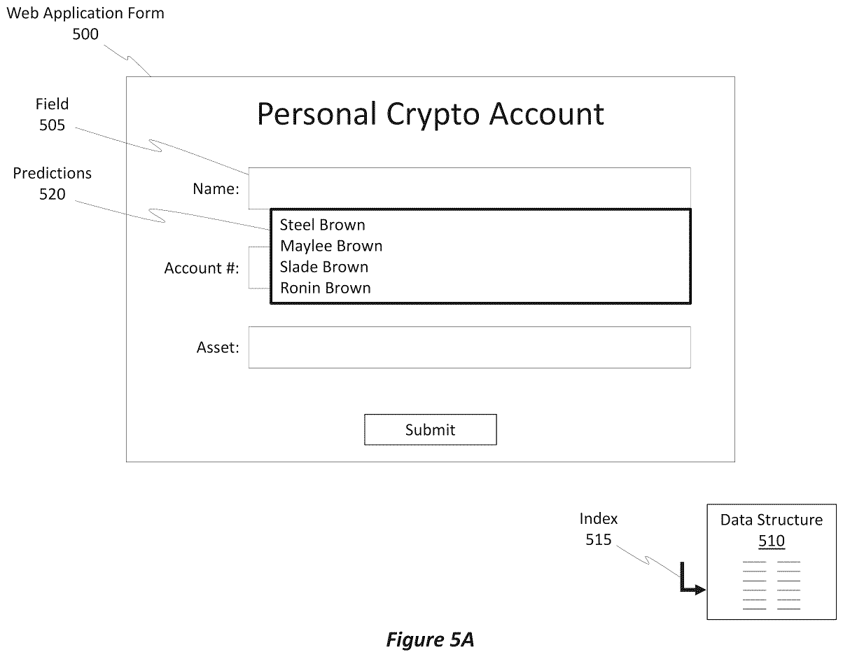

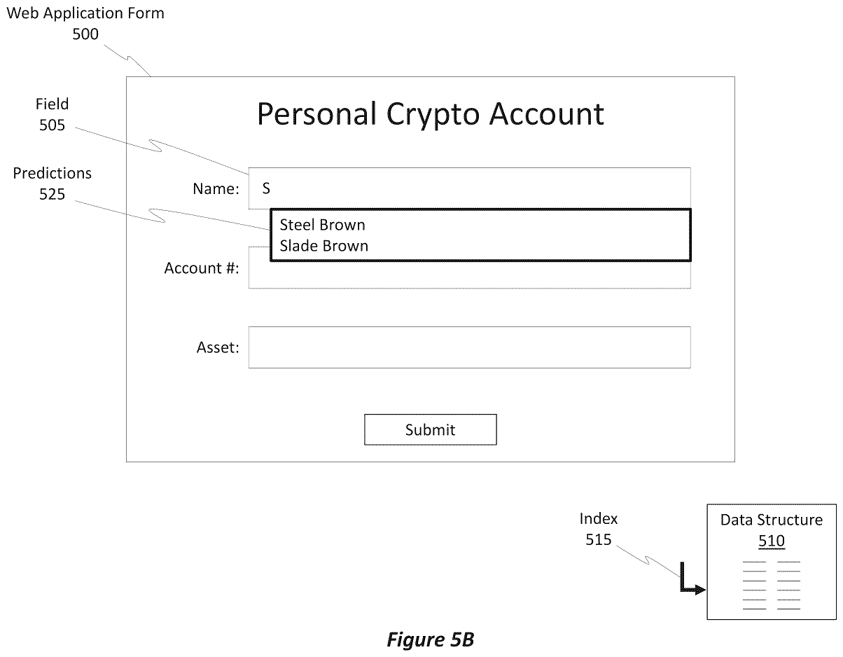

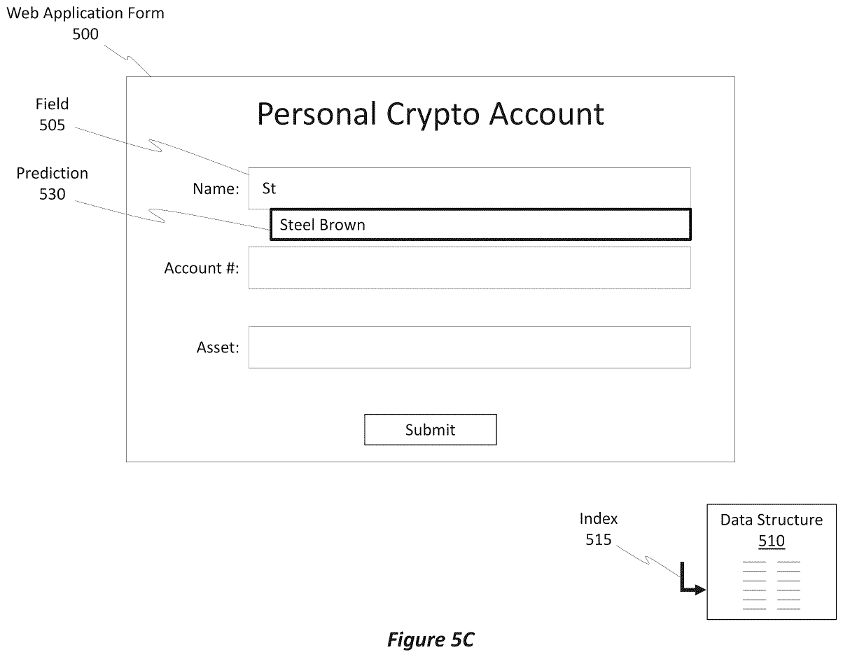

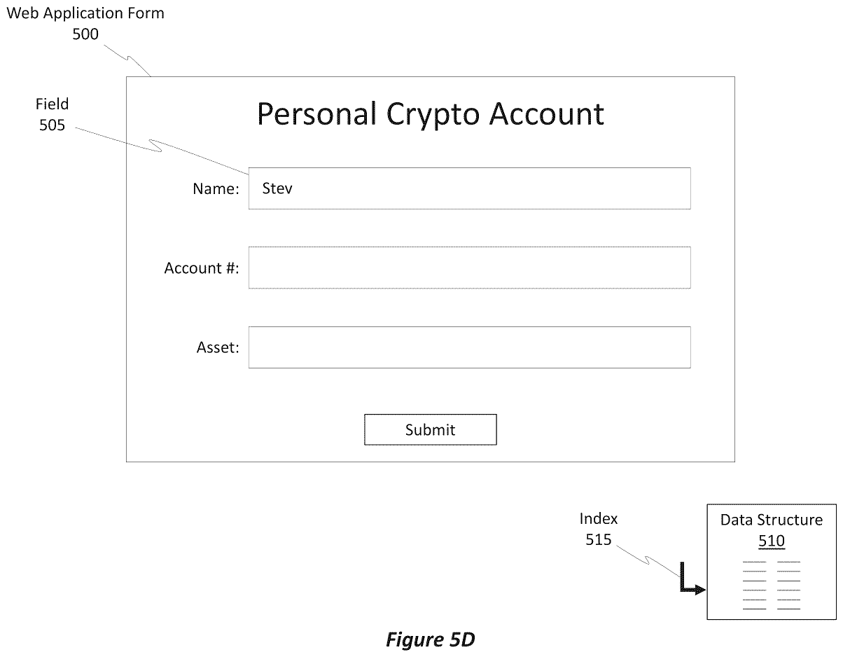

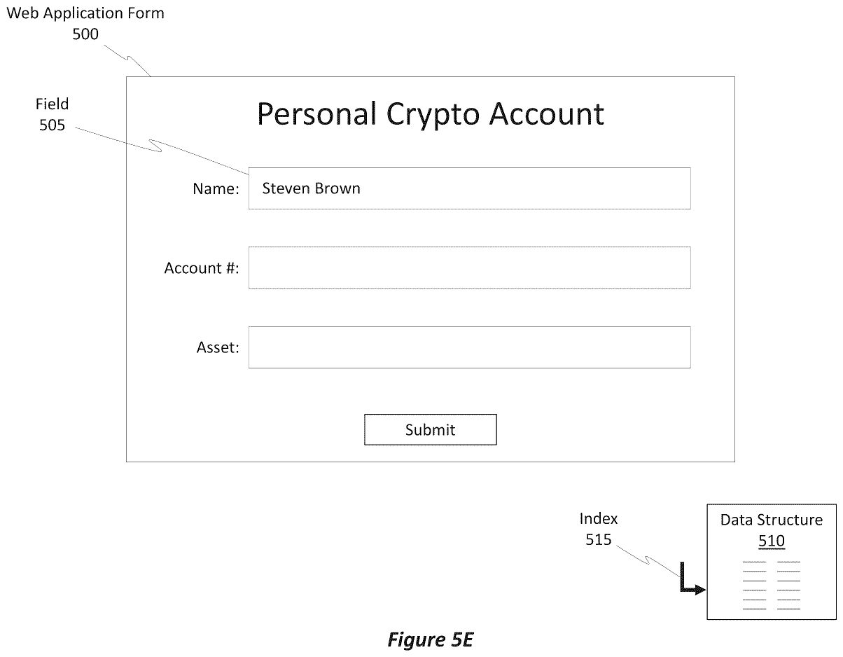

FIGS. 5A through 5E provide various example illustrations regarding a particular use case scenario involving a user interface. A person skilled in the art will recognize how these illustrates, and in particular the user interfaces, are provided for example purposes only and should not be viewed as limiting the disclosed principles. Other user interfaces and other techniques for surfacing the predictions can be used.

FIG. 5A shows an example web application form 500 that is representative of the web form 120 from FIG. 1. Web application form 500 includes a field 505 that corresponds to the other fields mentioned herein.

FIG. 5A also shows a data structure 510 that is indexed, as shown by index 515. The data structure 510 corresponds to the indexed data structure 130 from FIG. 1 and can include the predictions 335A from FIG. 3. The data structure 510 is stored locally on a client device, such as client device 305. The index 515 can be viewed as being the typed substring. For instance, in FIG. 5A, the index 515 is an empty string. In FIG. 5B, the index 515 is the letter “S.” In FIG. 5C, the index 515 includes the letters “St” and so on.

In FIG. 5A, the data structure 510 is received even before the user enters any data values into the field 505. In some cases, the data structure 510 can be received even before the web application form 500 is accessed. In other cases, accessing the web application form 500 triggers the receipt of the data structure 510.

Before the user enters any value into the field 505, at least one embodiment is able to query the data structure 510 and generate a list of one or more predictions that pertain or that are relevant to the field 505. By “relevant,” it is meant that the predictions are generated for that specific field 505 in particular as opposed to being generated for a different field. The predictions are generated for the field 505 based on history data obtained from one or more sources, as discussed earlier.

In the scenario shown in FIG. 5A, the 1-best prediction is displayed (e.g., “Steel Brown”). In addition to the 1-best prediction, this particular example is presenting a scenario where a number of additional predictions 520 are also displayed (e.g., “Maylee Brown,” “Slade Brown,” and “Ronin Brown”). One will appreciate, however, how some embodiments display only a single prediction. Other embodiments can display multiple predictions. The determination as to which predictions to display can be based by following the operations outlined in the process flow 400 of FIG. 4.

FIG. 5B now presents a scenario where the user has entered a first value (e.g., the letter “S”) into the field 505. In response, at least one embodiment prunes the list of predictions by using the indexed data structure 510 to identify predictions that match the initial value provided in the field 505. In this particular scenario, two predictions 525 are available, both starting with the letter “S.” For instance, now the predictions “Steel Brown” and “Slade Brown” are displayed. The predictions “Maylee Brown” and “Ronin Brown” were pruned based on the user data. As with the earlier description, some embodiments can display only a single prediction while other embodiments display multiple predictions.

It should be reinforced how the client device performed a local pruning and local querying operation against the locally stored data structure 510. The client device is not submitting additional network calls to the server. Thus, in this scenario, the client device is operating in the paused state and is not operating in the active state.

FIG. 5C shows a scenario where the user has entered an additional value into the field 505, resulting in the display of prediction 530 (i.e. “Steel Brown”). Again, local pruning and querying operations against the locally cached data structure 510 were performed.

FIG. 5D shows a scenario where the user has entered two additional values into the field 505 such that the field 505 now includes the following characters: “Stev”. Notice, in this scenario, no predictions are displayed. No predictions are displayed because no predictions having the values “Stev” were included in the data structure 510. Also, because the client device is operating in the paused state, the client device is not obtaining an updated list of predictions. Thus, in this scenario, instead of acquiring new predictions, at least one embodiment is electing instead to not display any predictions.

FIG. 5E shows a scenario where the user has entered, to completion, the value for the field 505. That value is “Steven Brown.” At least one embodiment can discern that the value has been entered to completion by identifying a scenario where the user navigated away from the field 505. Additionally, or alternatively, completion can be determined based on the user selecting the “Submit” button. Additionally, or alternatively, the user can be entering values in other fields. Thus, multiple different conditions can exist for determining when a value has been entered to completion in the field 505.

In response to the value being entered to completion, the disclosed embodiments will identify that the value was not one that was included in the data structure 510. At least one embodiment can then transmit the value to the server for inclusion in the historical data. Subsequent data structures that are generated by the server can be structured to include this new value. Additionally, the client device can transition from operating in the paused state to the active state, at least with regard to the user's interaction with field 505. Different states of the client device can simultaneously exist for different fields of the web application form 500.

For instance, the field labeled “Account #” is a second field in the web application form 500. Although the client device can operate in the paused state with respect to the field 505, the client device can operate in the active state with respect to the “Account #” field. Thus, the client device can have different operational states for the different fields. Being in a state for a given field means that the client device will or will not suspend calls to the network server for that specific field. It can be the case that the client device does not suspend network calls for other fields, however.

The following discussion now refers to a number of methods and method acts that can be performed. Although the method acts can be discussed in a certain order or illustrated in a flow chart as occurring in a particular order, no particular ordering is required unless specifically stated, or required because an act is dependent on another act being completed prior to the act being performed.

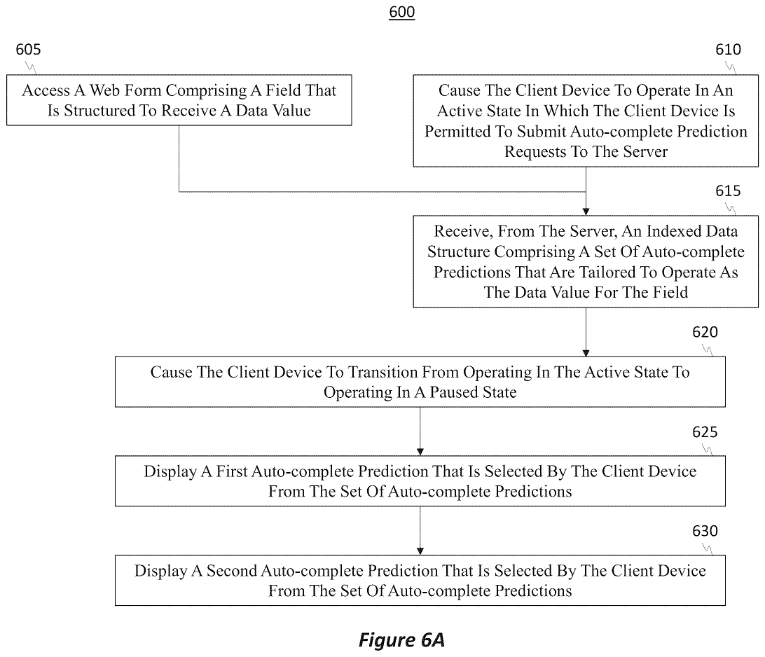

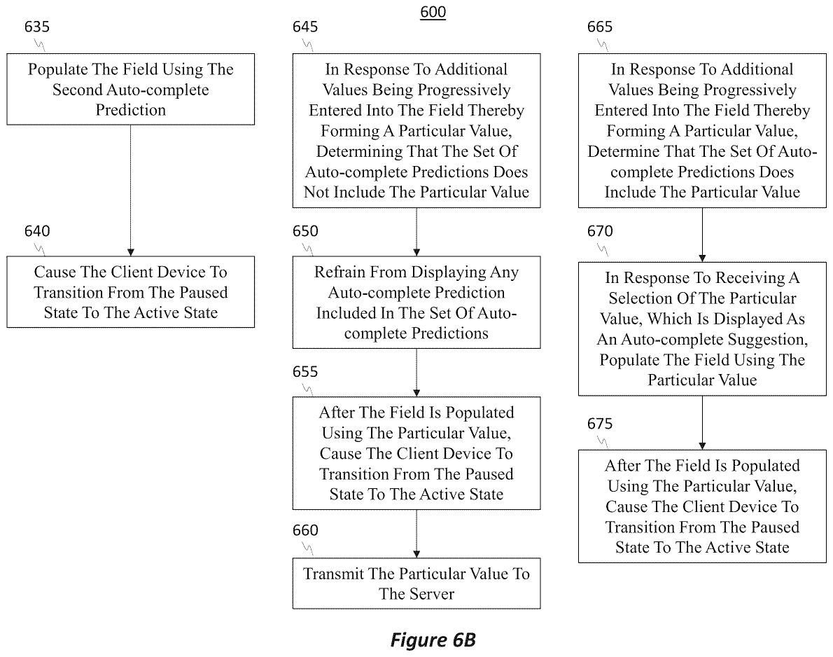

Attention will now be directed to FIGS. 6A and 6B, which illustrate flowcharts of an example method 600 for displaying predictions for a field of a web form. Method 600 can be implemented within the architecture 100 of FIG. 1, and method 600 can be performed by service 105. That is, method 600 can be implemented by a client device (e.g., client device 305 of FIG. 3) that communicates with a server (e.g., service 310).

Method 600 includes an act (act 605) of accessing a web form comprising a field that is structured to receive a data value. Web application form 200 of FIG. 2 is one example. Notice, web application form 200 includes multiple fields structured to receive data values.

Act 610 includes causing the client device to operate in an active state in which the client device is permitted to submit autocomplete prediction requests to the server. FIG. 3 particularly illustrates how the client device 305 can operate in the active state 345.

Prior to receiving user input directed to the field, act 615 includes receiving, from the server, an indexed data structure comprising a set of autocomplete predictions that are tailored to operate as the data value for the field. The indexed data structure 130 of FIG. 1 is illustrative.

After the indexed data structure is received from the server and before the user input directed to the field is received, act 620 includes causing the client device to transition from operating in the active state to operating in a paused state. While in the paused state, the client device is caused to refrain (or is prevented) from submitting any requests for any additional autocomplete predictions with respect to the given field in focus. This refraining persists until after the field is populated with the data value. It can be the case, however, that requests can be submitted for other fields in the form. For instance, the client device might be operating in the active state for those other fields, but the client device is currently operating in the paused state for this particular field.

Prior to the user input being entered into the field, act 625 includes displaying a first autocomplete prediction. This first autocomplete prediction is selected by the client device from the set of autocomplete predictions. Note, the client device performed this selection, not the server.

In response to identifying a single value being entered into the field, act 630 includes displaying a second autocomplete prediction that is selected by the client device from the set of autocomplete predictions. Again note, this selection is performed by the client device, not the server. The second autocomplete prediction is selected by the client device based on the client device querying the indexed data structure using the single value. Also note, the client device is locally operating with the static indexed data structure. It should be noted how the “single value” can include one or more alphanumeric characters.

Method 600 continues in FIG. 6B. After act 630 is performed, method 600 can continue down one of three different vertical branches, as shown in FIG. 6B. For example, in response to receiving a selection of the second autocomplete prediction, act 635 (included in the first branch) includes populating the field using the second autocomplete prediction. After the field is populated using the second autocomplete prediction, act 640 then includes causing the client device to transition from the paused state to the active state.

On the other hand, in response to one or more additional values being progressively entered into the field thereby forming a particular value, act 645 (included in the second branch) includes determining that the set of autocomplete predictions does not include the particular value. Act 650 then includes refraining from displaying any autocomplete prediction included in the set of autocomplete predictions. After the field is populated using the particular value, act 655 includes causing the client device to transition from the paused state to the active state. Act 660 then includes transmitting the particular value to the server. Here, the particular value can be included in a history that is maintained for at least one of: (i) the field of the web form, (ii) the web form, (iii) a user who provided the user input, or (iv) a user session associated with the web form. The particular value can later be included in an updated set of autocomplete predictions that are subsequently generated for the field.

On the other hand, in response to one or more additional values being progressively entered into the field thereby forming a particular value, act 665 (included in the third branch) includes determining that the set of autocomplete predictions does include the particular value. In response to receiving a selection of the particular value, which is displayed as an autocomplete suggestion, act 670 includes populating the field using the particular value. After the field is populated using the particular value, act 675 includes causing the client device to transition from the paused state to the active state.

In some implementations, the set of autocomplete predictions are ranked predictions based on a corresponding confidence metric or frequency assigned to each corresponding autocomplete prediction included in the set of autocomplete predictions. Optionally, the set of autocomplete predictions include at least one autocomplete prediction generated via a large language model. As another option, at least one autocomplete prediction included in the set of autocomplete predictions is generated based on a history that is maintained for the field. As another option, at least one autocomplete prediction included in the set of autocomplete predictions is generated based on a history that is maintained for the web form.

In some scenarios, at least one autocomplete prediction included in the set of autocomplete predictions is generated based on a history that is maintained for a user who is providing the user input. In some scenarios, at least one autocomplete prediction included in the set of autocomplete predictions is generated based on a history that is maintained for a session associated with the web form.

Optionally, the first autocomplete prediction can be displayed simultaneously with a plurality of other autocomplete predictions included in the set of autocomplete predictions. Optionally, the first autocomplete prediction can be displayed without any other autocomplete predictions from the set of autocomplete predictions being displayed.

The indexed data structure can be stored in memory of the client device. Also, the indexed data structure can subsequently be queried without being updated by the server. Beneficially, the indexed data structure is stored locally in cache of the client device. As such, the client device querying the indexed data structure is a local operation that is local to the client device. The autocomplete predictions included in the data structure remain unchanged while the client device is operating in the paused state. That is, the data structure is static.

Notably, while the client device is operating in the paused state, no calls are made to the server by the client device. In some embodiments, while the client device is operating in the paused state, no data is received at the client device from the server.

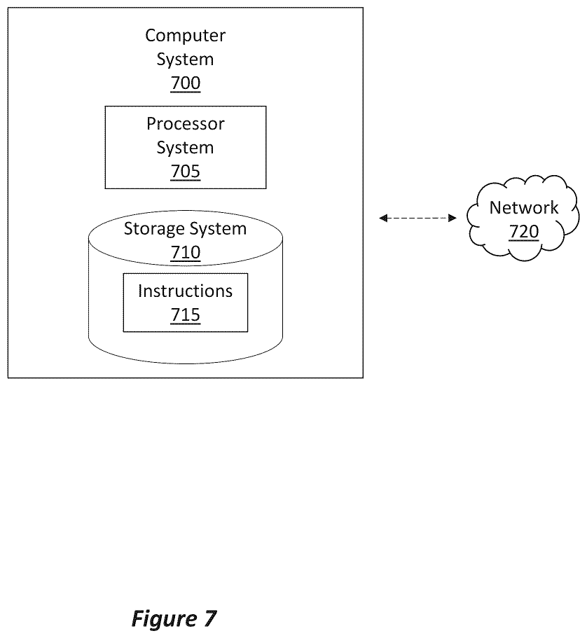

Attention will now be directed to FIG. 7 which illustrates an example computer system 700 that can include and/or be used to perform any of the operations described herein. For instance, computer system 700 can implement architecture 100 of FIG. 1; also, computer system 700 can host service 105. Computer system 700 can take various different forms. For example, computer system 700 can be embodied as a tablet, a desktop, a laptop, a mobile device, or a standalone device, such as those described throughout this disclosure. Computer system 700 can also be a distributed system that includes one or more connected computing components/devices that are in communication with computer system 700.

In its most basic configuration, computer system 700 includes various different components. FIG. 7 shows that computer system 700 includes a processor system 705 that includes one or more hardware processor(s) (aka a “hardware processing unit”) and a storage system 710 that includes one or more hardware storage devices.

Regarding the processor(s) of processors system 705, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that can be executed on computer system 700. The different components, modules, engines, and services described herein can be implemented as objects or processors that execute on computer system 700 (e.g. as separate threads).

Storage system 710 can be physical system memory, which can be volatile, non-volatile, or some combination of the two. The term “memory” can also be used herein to refer to non-volatile mass storage such as physical storage media. If computer system 700 is distributed, the processing, memory, and/or storage capability can be distributed as well.

Storage system 710 is shown as including executable instructions 715. The executable instructions 715 represent instructions that are executable by the processor(s) of the processor system 705 to perform the disclosed operations, such as those described in the various methods.

The disclosed embodiments can comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 700 can also be connected (via a wired or wireless connection) to external sensors (e.g., one or more remote cameras) or devices via a network 720. For example, computer system 700 can communicate with any number devices or cloud services to obtain or process data. In some cases, network 720 can itself be a cloud network. Furthermore, computer system 700 can also be connected through one or more wired or wireless networks to remote/separate computer systems(s) that are configured to perform any of the processing described with regard to computer system 700.

A “network,” like network 720, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 700 will include one or more communication channels that are used to communicate with the network 720. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that at least one embodiment can be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. At least one embodiment can also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules can be located in both local and remote memory storage devices.

The present invention can be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method implemented by a client device that communicates with a server, said method comprising:
accessing a web form comprising a field that is structured to receive a data value;
causing the client device to operate in an active state in which the client device is permitted to submit autocomplete prediction requests to the server;
prior to receiving user input directed to the field, receiving, from the server, an indexed data structure comprising a set of autocomplete predictions that are tailored to operate as the data value for the field;
after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value;
prior to the user input being entered into the field, displaying a first autocomplete prediction that is selected by the client device from the set of autocomplete predictions;
in response to identifying a single value being entered into the field, displaying a second autocomplete prediction that is selected by the client device from the set of autocomplete predictions, wherein the second autocomplete prediction is selected by the client device based on the client device querying the indexed data structure using the single value;
in response to receiving a selection of the second autocomplete prediction, populating the field using the second autocomplete prediction; and
after the field is populated using the second autocomplete prediction, causing the client device to transition from the paused state to the active state.

2. The method of claim 1, wherein the set of autocomplete predictions are ranked predictions based on a corresponding confidence metric assigned to each corresponding autocomplete prediction included in the set of autocomplete predictions.

3. The method of claim 1, wherein the single value includes one or more alphanumeric characters.

4. The method of claim 1, wherein at least one autocomplete prediction included in the set of autocomplete predictions is generated based on a history that is maintained for the field.

5. The method of claim 1, wherein at least one autocomplete prediction included in the set of autocomplete predictions is generated based on a history that is maintained for the web form.

6. The method of claim 1, wherein at least one autocomplete prediction included in the set of autocomplete predictions is generated based on a history that is maintained for a user who is providing the user input.

7. The method of claim 1, wherein at least one autocomplete prediction included in the set of autocomplete predictions is generated based on a history that is maintained for a session associated with the web form.

8. The method of claim 1, wherein the first autocomplete prediction is displayed simultaneously with a plurality of other autocomplete predictions included in the set of autocomplete predictions.

9. The method of claim 1, wherein the first autocomplete prediction is displayed without any other autocomplete predictions from the set of autocomplete predictions being displayed.

10. The method of claim 1, wherein the indexed data structure is stored in memory of the client device, and wherein the indexed data structure is subsequently queried without being updated by the server.

11. A method implemented by a client device that communicates with a server, said method comprising:
accessing a web form comprising a field that is structured to receive a data value;
causing the client device to operate in an active state in which the client device is permitted to submit autocomplete prediction requests to the server;
prior to receiving user input directed to the field, receiving, from the server, an indexed data structure comprising a set of autocomplete predictions that are tailored to operate as the data value for the field;
after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value;
prior to the user input being entered into the field, displaying a first autocomplete prediction that is selected by the client device from the set of autocomplete predictions;
in response to identifying a single value being entered into the field, displaying a second autocomplete prediction that is selected by the client device from the set of autocomplete predictions, wherein the second autocomplete prediction is selected by the client device based on the client device querying the indexed data structure using the single value;
in response to one or more additional values being progressively entered into the field thereby forming a particular value, determining that the set of autocomplete predictions does not include the particular value;
refraining from displaying any autocomplete prediction included in the set of autocomplete predictions;
after the field is populated using the particular value, causing the client device to transition from the paused state to the active state; and
transmitting the particular value to the server.

12. The method of claim 11, wherein the particular value is included in a history that is maintained for at least one of: (i) the field of the web form, (ii) the web form, (iii) a user who provided the user input, or (iv) a user session associated with the web form.

13. The method of claim 11, wherein the particular value is included in an updated set of autocomplete predictions that are subsequently generated for the field.

14. The method of claim 11, wherein the indexed data structure is stored locally in cache of the client device.

15. The method of claim 11, wherein, while the client device is operating in the paused state, no calls are made to the server by the client device.

16. The method of claim 11, wherein the indexed data structure is stored locally in cache of the client device, and wherein the client device querying the indexed data structure is a local operation that is local to the client device.

17. The method of claim 11, wherein, while the client device is operating in the paused state, no data is received at the client device from the server.

18. The method of claim 11, wherein the autocomplete predictions included in the data structure remain unchanged while the client device is operating in the paused state.

19. The method of claim 11, wherein the data structure is static.

20. A method implemented by a client device that communicates with a server, said method comprising:
accessing a web form comprising a field that is structured to receive a data value;
causing the client device to operate in an active state in which the client device is permitted to submit autocomplete prediction requests to the server;
prior to receiving user input directed to the field, receiving, from the server, an indexed data structure comprising a set of autocomplete predictions that are tailored to operate as the data value for the field;
after the indexed data structure is received from the server and before the user input directed to the field is received, causing the client device to transition from operating in the active state to operating in a paused state in which the client device is caused to refrain from submitting any requests for any additional autocomplete predictions for said field, said refraining persisting until after the field is populated with the data value;
prior to the user input being entered into the field, displaying a first autocomplete prediction that is selected by the client device from the set of autocomplete predictions;
in response to identifying a single value being entered into the field, displaying a second autocomplete prediction that is selected by the client device from the set of autocomplete predictions, wherein the second autocomplete prediction is selected by the client device based on the client device querying the indexed data structure using the single value;
in response to one or more additional values being progressively entered into the field thereby forming a particular value, determining that the set of autocomplete predictions does include the particular value;
in response to receiving a selection of the particular value, which is displayed as an autocomplete suggestion, populating the field using the particular value; and
after the field is populated using the particular value, causing the client device to transition from the paused state to the active state.
